(19) United States
(12) Patent Application Publication
(10) Pub. No.: US 2024/0342604 A1
(43) Pub. Date: Oct. 17, 2024

(54) CONTROL METHOD AND APPARATUS FOR VIRTUAL OBJECT, STORAGE MEDIUM, AND ELECTRONIC DEVICE

(71) Applicant: Tencent Technology (Shenzhen) Company Limited, Shenzhen (CN)

(72) Inventors: Yinchao CHEN, Shenzhen (CN); Ya ZHANG, Shenzhen (CN); Han WEN, Shenzhen (CN); Luyu SUN, Shenzhen (CN); Yiqi LI, Shenzhen (CN); Lijin WANG, Shenzhen (CN); Huizhong ZHANG, Shenzhen (CN)

(73) Assignee: Tencent Technology (Shenzhen) Company Limited, Shenzhen (CN)

(21) Appl. No.: 18/751,119

(22) Filed: Jun. 21, 2024

Related U.S. Application Data
(63) Continuation of application No. PCT/CN2023/121483, filed on Sep. 26, 2023.

(30) Foreign Application Priority Data
Oct. 14, 2022 (CN) 202211261278.5

(51) Int. Cl. A63F 13/56; A63F 13/52

(52) U.S. Cl. CPC A63F 13/56; A63F 13/52

(57) ABSTRACT

In a control method for a virtual object, a target control is displayed in a display interface of a first virtual scene. The first virtual scene corresponds to a first perspective of a target virtual object. An operation prompt based on the first perspective on the target control is displayed based on a touch operation. The operation prompt is configured to display a casting action range of a target virtual item. Casting preview information of the target virtual item is displayed in the first virtual scene when the touch operation stops at a first stop position in the operation prompt. The first virtual scene displayed in the display interface is adjusted to a second virtual scene. The second virtual scene corresponds to a second perspective of the target virtual object.

### RELATED APPLICATIONS

The present application is a continuation of International Application No. PCT/CN2023/121483, filed on Sep. 26, 2023, which claims priority to Chinese Patent Application No. 202211261278.5, filed on Oct. 14, 2022. The entire disclosures of the prior applications are hereby incorporated by reference.

### FIELD OF THE TECHNOLOGY

This disclosure relates to the computer field, including a control method and apparatus for a virtual object, a storage medium, and an electronic device.

### BACKGROUND OF THE DISCLOSURE

As the performance of mobile devices upgrades from generation to generation, role-playing 3D live-action games become more common. Various previous gameplay of client games and console games has been transplanted to mobile phones, and therefore various special operations need to be implemented on the mobile phones. For example, in client games, a visual field and a skill casting operation of a virtual character may be controlled by a keyboard and a mouse respectively. However, in mobile games, usually the virtual character can only be controlled in a touch form, and therefore adjustments for the visual field and the skill casting of the virtual character can only be implemented sequentially through two different touch operations. For example, when a game perspective is fixed, a skill casting trajectory is adjusted through the touch operation, or when the skill trajectory is fixed, the game perspective is adjusted through the touch operation.

The related control method for a virtual object has a technical problem of low control efficiency. In view of the foregoing problem, no effective solution has been provided yet.

### SUMMARY

This disclosure provides a control method and apparatus for a virtual object, a non-transitory computer-readable storage medium, and an electronic device, to address at least the technical problem of low efficiency in the related control method for a virtual object.

According to an aspect of this disclosure, a control method for a virtual object is provided. In the method, a target control is displayed in a display interface of a first virtual scene. The first virtual scene corresponds to a first perspective of a target virtual object. An operation prompt based on the first perspective on the target control is displayed based on a touch operation. The operation prompt is configured to display a casting action range of a target virtual item. Casting preview information of the target virtual item is displayed in the first virtual scene when the touch operation stops at a first stop position in the operation prompt. The first virtual scene displayed in the display interface is adjusted to a second virtual scene. The second virtual scene corresponds to a second perspective of the target virtual object.

According to an aspect of this disclosure, a control apparatus for a virtual object is further provided. The apparatus includes processing circuitry configured to display a target control in a display interface of a first virtual scene. The first virtual scene corresponds to a first perspective of a target virtual object. The processing circuitry is configured to display an operation prompt based on the first perspective on the target control and a touch operation. The operation prompt is configured to display a casting action range of a target virtual item. The processing circuitry is configured to display casting preview information of the target virtual item in the first virtual scene when the touch operation stops at a first stop position in the operation prompt. The processing circuitry is configured to adjust the first virtual scene displayed in the display interface to a second virtual scene corresponding to a second perspective of the target virtual object.

According to an aspect of this disclosure, a non-transitory computer-readable storage medium is further provided. The non-transitory computer-readable storage medium has a computer program stored therein, the computer program, when run, configured to perform the foregoing control method for a virtual object.

According to still another aspect of this disclosure, a computer program product is provided. The computer program product includes computer programs/instructions, the computer instructions being stored in a computer-readable storage medium. A processor of a computer device reads the computer programs/instructions from the computer-readable storage medium. The processor executes the computer programs/instructions to enable the computer device to perform the foregoing control method for a virtual object.

According to still another aspect of this disclosure, an electronic device is further provided. The electronic device includes a memory and a processor, the memory having a computer program stored therein, and the processor being configured to perform the foregoing control method for a virtual object through the computer program.

In an example, the target control is displayed in the display interface in which the first virtual scene picture is displayed, where the first virtual scene picture is the picture of the virtual scene observed by the target virtual object from the first perspective; the operation prompt layer matching the first perspective is overlay-displayed on the target control in response to the touch operation on the target control, where the operation prompt layer is configured for prompting the casting action range of the target virtual item usable by the target virtual object; and when it is determined that the touch point moves to the second stop position outside the first display area in which the operation prompt layer currently displayed is located, the operation prompt layer is adjusted to the second display area matching the second stop position, and the first virtual scene picture displayed in the display interface is adjusted to the second virtual scene picture, to display a special operation control configured to control the virtual object in the display interface. In this way, the operation prompt layer is displayed when the touch operation on the target control is detected, so that the casting action range of the virtual item is accurately controlled based on a position of the touch point in the operation prompt layer, and a function of quickly adjusting a game perspective is provided when the touch point is at a special position. Therefore, one operation can be provided to control the virtual object to cast the item and adjust the perspective of the virtual object simultaneously, thereby providing abundant control effects and improving control efficiency of the virtual object, to resolve the technical problem of low efficiency in the existing control method for a virtual object.

### BRIEF DESCRIPTION OF THE DRAWINGS

The accompanying drawings described herein are used to provide a further understanding of this disclosure, and form a part of this disclosure. Examples of this disclosure and descriptions thereof are used to explain this disclosure, and do not constitute a limitation to this disclosure. In the accompanying drawings:

FIG. 1 is a schematic diagram of a hardware environment of a control method for a virtual object according to an aspect of this disclosure.

FIG. 2 is a flowchart of a control method for a virtual object according to an aspect of this disclosure.

FIG. 3 is a schematic diagram of a control method for a virtual object according to an aspect of this disclosure.

FIG. 4 is a schematic diagram of another control method for a virtual object according to an aspect of this disclosure.

FIG. 5 is a schematic diagram of still another control method for a virtual object according to an aspect of this disclosure.

FIG. 6 is a schematic diagram of still another control method for a virtual object according to an aspect of this disclosure.

FIG. 7 is a schematic diagram of still another control method for a virtual object according to an aspect of this disclosure.

FIG. 8 is a schematic diagram of still another control method for a virtual object according to an aspect of this disclosure.

FIG. 9 is a schematic diagram of still another control method for a virtual object according to an aspect of this disclosure.

FIG. 10 is a schematic diagram of still another control method for a virtual object according to an aspect of this disclosure.

FIG. 11 is a schematic diagram of still another control method for a virtual object according to an aspect of this disclosure.

FIG. 12 is a schematic diagram of still another control method for a virtual object according to an aspect of this disclosure.

FIG. 13 is a schematic diagram of still another control method for a virtual object according to an aspect of this disclosure.

FIG. 14 is a schematic diagram of still another control method for a virtual object according to an aspect of this disclosure.

FIG. 15 is a schematic diagram of still another control method for a virtual object according to an aspect of this disclosure.

FIG. 16 is a flowchart of another control method for a virtual object according to an aspect of this disclosure.

FIG. 17 is a schematic structural diagram of a control apparatus for a virtual object according to an aspect of this disclosure.

FIG. 18 is a schematic structural diagram of an electronic device according to an aspect of this disclosure.

### DETAILED DESCRIPTION

To aid a person skilled in the art to better understand solutions of this application, the following describes technical solutions in this disclosure with reference to the accompanying drawings. Other aspects obtained by a person of ordinary skill in the art based on this disclosure shall fall within the protection scope of the disclosure.

In the specification, claims, and accompanying drawings of this application, terms “first”, “second”, and the like are intended to distinguish between similar objects, but do not necessarily indicate a specific order or sequence. Data used in this way may be interchanged in an appropriate case, so that aspects of this disclosure described herein can be implemented in other orders than the order illustrated or described herein. In addition, terms “include”, “have”, and any other variants thereof are intended to cover a non-exclusive inclusion. For example, a process, method, system, product, or device that includes a list of operations or units is not limited to those expressly listed operations or units, but may include other operations or units not expressly listed or inherent to the process, method, product, or device.

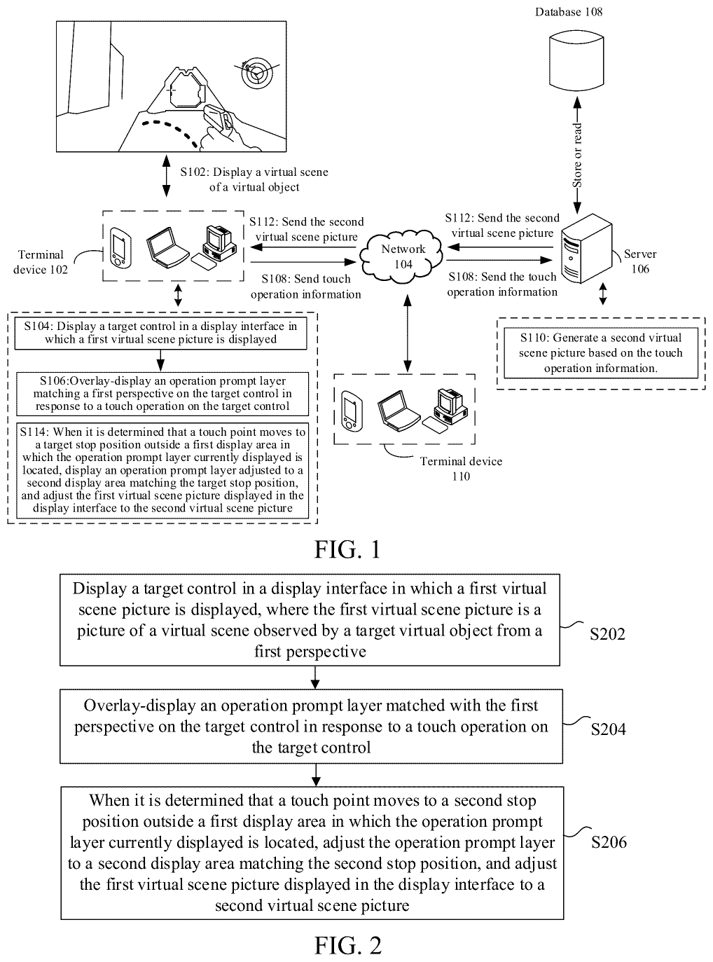

According to an aspect of this disclosure, a control method for a virtual object is provided. As an implementation, the control method for a virtual object may be applied to, but is not limited to, a control system for a virtual object in a hardware environment shown in FIG. 1. The control system for a virtual object may include, but is not limited to, a terminal device 102, a network 104, a server 106, a database 108, and a terminal device 110. A target client (as shown in FIG. 1, for example, the target client is a game application client) is run in each of the terminal device 102 and the terminal device 110. Each of the terminal device 102 and the terminal device 110 includes a human-computer interaction screen, a processor, and a memory. The human-computer interaction screen is configured to display a virtual game scene (as the virtual game scene shown in FIG. 1), and is further configured to provide a human-computer interaction interface to receive a human-computer interaction operation for controlling a controlled virtual object in a virtual scene. The virtual object completes a game task set in the virtual scene. The processor is configured to generate an interactive instruction in response to the human-computer interaction operation and send the interactive instruction to the server. The memory is configured to store relevant attribute data, such as object attribute information of the controlled virtual object, and attribute information of a held virtual item. The attribute information may include, but is not limited to, information for identifying an identity, a current position, and the like thereof. A client controlling a first virtual object is run in the terminal device 102. In some aspects, when a second virtual object is a virtual object controlled by a terminal device, a client controlling the second virtual object is run in the terminal device 110. The second virtual object and the first virtual object may be controlled in the game to perform some interactive events, such as an attack event, a defense event, and a skill casting event.

In addition, the server 106 includes a processing engine. The processing engine is configured to perform a store or read operation on the database 108. Specifically, the processing engine reads virtual scene information of each virtual object and operation information performed by each virtual object from the database 108. Assuming that the terminal device 102 in FIG. 1 is configured to control the first virtual object, and the terminal device 110 is configured to control the second virtual object in the same game task, a specific process includes the following operations. S102 to S106: Display a virtual scene in which the first virtual object is located in the terminal device 102; display a target control in a display interface in which a first virtual scene picture is displayed, the first virtual scene picture being a picture of a virtual scene observed by a target virtual object from a first perspective; overlay-displaying an operation prompt layer matching the first perspective on the target control in response to a touch operation on the target control, the operation prompt layer being configured for prompting a casting action range of a target virtual item usable by the target virtual object; and when a touch point corresponding to the touch operation stops at a first stop position in the operation prompt layer, casting preview information of the target virtual item matching the first stop position being displayed in the first virtual scene picture. S108: The terminal device 102 sends touch operation information to the server 106 through the network 104; and the server 106 performs S110, to generate a second virtual scene picture based on the touch operation information. S112: The server 106 sends the second virtual scene picture to the terminal device 102 through the network 104, and performs S114 in the terminal device 102. S114: When it is determined that the touch point moves to a second stop position outside a first display area in which the operation prompt layer currently displayed is located, adjust the operation prompt layer to a second display arca matching the second stop position, and adjust the first virtual scene picture displayed in the display interface to a second virtual scene picture, the second virtual scene picture being a picture of a virtual scene observed by the target virtual object from a second perspective.

As another implementation, when the terminal device 102 or the terminal device 110 has a powerful computing processing capability, S110 may alternatively be completed by the terminal device 102 or the terminal device 110. The foregoing is an example, and this is not limited in this disclosure.

In an aspect, the terminal device may be a terminal device configured with a target client, and may include, but is not limited to, at least one of the following: a mobile phone (such as an Android mobile phone or an IOS mobile phone), a notebook computer, a tablet computer, a palmtop computer, a mobile Internet device (MID), a PAD, a desktop computer, a smart television, and the like. The target client may be a client that supports providing a shooting game task, such as a video client, an instant messaging client, a browser client, or an education client. The network may include, but is not limited to, a wired network and a wireless network. The wired network includes a local area network, a metropolitan area network, and a wide area network. The wireless network includes Bluetooth, wireless fidelity (Wi-Fi), and another network that implements wireless communication. The server may be a single server, a server cluster including a plurality of servers, or a cloud server. The foregoing is merely an example, and this is not limited in this embodiment.

In an aspect, the control method for a virtual object may be applied to, but is not limited to, a game terminal application (APP) that completes a given battle game task in a virtual scene, such as a virtual battle game application in a multiplayer online battle arena (MOBA) application. The battle game task may be, but is not limited to, a game task completed by a current player controlling a virtual object in a virtual scene through a human-computer interaction operation to battle and interact with a virtual object controlled by another player. The control method for a virtual object may also be applied to a massive multiplayer online role-playing game (MMORPG) terminal application. In such a game, the current player may complete a social game task in the game from a first perspective of a virtual object through role-playing, for example, complete the game task together with other virtual objects. The social game task may be run in, but is not limited to, an application (such as a non-stand-alone game app) in a form of a plug-in or an applet, or may be run in an application (such as a stand-alone game app) in a game engine. A type of the game application may include, but is not limited to, at least one of the following: a two-dimensional (2D) game application, a three-dimensional (3D) game application, a virtual reality (VR) game application, an augmented reality (AR) game application, and a mixed reality (MR) game application. The foregoing is merely an example, and this is not limited in this aspect.

The foregoing implementation of this disclosure may also be applied to, but is not limited to, an open world game. The open world refers to that a battle scene in the game is completely free and open, a player may freely advance and explore in any direction, and distances between boundaries of orientations are extremely large. In addition, there are simulation objects of various shapes and sizes in the scene, so that various physical collisions or interactions with entities such as the player and AI can be generated. In the open world game, the player may control a virtual object to battle and interact to complete a game task.

In an aspect of this disclosure, the target control is displayed in the display interface in which the first virtual scene picture is displayed, where the first virtual scene picture is the picture of the virtual scene observed by the target virtual object from the first perspective; the operation prompt layer matching the first perspective is overlay-displayed on the target control in response to the touch operation on the target control, where the operation prompt layer is configured for prompting the casting action range of the target virtual item usable by the target virtual object; and when it is determined that the touch point moves to the second stop position outside the first display area in which the operation prompt layer currently displayed is located, the operation prompt layer is adjusted to the second display area matching the second stop position, and the first virtual scene picture displayed in the display interface is adjusted to the second virtual scene picture. In this way, a special operation control configured to control the virtual object is displayed in the display interface, so that the operation prompt layer is displayed when the touch operation on the target control is detected, to accurately control the casting action range of the virtual item based on the position of the touch point in the operation prompt layer. When the touch point is at a special position, the operation prompt layer is adjusted to the second display area matching the second stop position, and the first virtual scene picture displayed in the display interface is adjusted to the second virtual scene picture, where the second virtual scene picture is the picture of the virtual scene observed by the target virtual object from the second perspective.

As an implementation, as shown in FIG. 2, the control method for a virtual object includes the following operations.

S202: Display a target control in a display interface in which a first virtual scene picture is displayed, the first virtual scene picture being a picture of a virtual scene observed by a target virtual object from a first perspective.

In an aspect, the first virtual scene picture is the picture of the virtual scene observed by the target virtual object from the first perspective.

S204: Overlay-display an operation prompt layer matching the first perspective on the target control in response to a touch operation on the target control.

The operation prompt layer is configured for prompting a casting action range of a target virtual item usable by the target virtual object, and when a touch point corresponding to the touch operation stops at a first stop position in the operation prompt layer, casting preview information of the target virtual item matching the first stop position is displayed in the first virtual scene picture. The operation prompt layer may be configured for prompting the casting action range of the target virtual item that can be invoked by the target virtual object, when the target virtual object is located at the position.

The first stop position in the operation prompt layer may be a position in a preset area that is configured for stopping the touch point and that is in the operation prompt layer.

S206: When it is determined that the touch point moves to a second stop position outside a first display area in which the operation prompt layer currently displayed is located, adjust the operation prompt layer to a second display area matching the second stop position, and adjust the first virtual scene picture displayed in the display interface to a second virtual scene picture.

The second virtual scene picture is a picture of a virtual scene observed by the target virtual object from a second perspective. That is, the second virtual scene picture is the picture of the virtual scene from the second perspective of the target virtual object. The second stop position may be a position in a preset area that is configured for stopping the touch point and that is outside the first display area in which the operation prompt layer currently displayed is located.

In this implementation, the target virtual object may be a virtual character, a virtual image, or a virtual person that are controlled by a player in a game. The player may control the target virtual object to perform the operation corresponding to the target control through the method in the foregoing operations, and simultaneously adjust the perspective of the target object, to switch between different game scene pictures.

In S202, the target control may be an attack control configured to trigger an attack operation, or a skill control configured to trigger a skill operation. For example, the target control may be an attack item control corresponding to a virtual attack item, or the target control may be a skill control corresponding to a virtual skill. An operation type corresponding to the target control is not limited in this implementation.

In an aspect, the touch operation in S204 may be a touch and hold operation, a single tap operation, or a double tap operation. A type of the touch operation is not limited in this implementation.

The operation prompt layer matching the first perspective in S204 means that: the operation prompt layer corresponds to the first perspective of the target virtual object, and an arca displayed in the operation prompt layer may be configured for indicating the virtual scene observed by the target virtual object from the first perspective. The operation prompt layer in S204 may be a display layer overlay-displayed on the target control, a display range of the layer is configured for indicating the virtual scene observed by a currently controlled virtual object from the first perspective, and the casting preview information of the target virtual item of the target control is indicated by an element displayed in the operation prompt layer. For example, the casting preview information may be operation aiming information, operation action range information, and operation target information. For example, when a control operation corresponding to the target control is a shooting operation, a prompt pattern configured for indicating the aiming information may be displayed in the operation prompt layer. As an example, the aiming information may be indicated based on a direction of a prompt line displayed in the operation prompt layer. In another manner, shooting curve information of a shooting item may be indicated by a curve displayed in the prompt layer. In another example, when the control operation corresponding to the target control is a skill casting operation of a special item, a prompt pattern configured for indicating the action range information of the skill casting may be displayed in the operation prompt layer. In an example, trajectory information of the skill casting may be indicated based on an action curve displayed in the operation prompt layer. In another example, an entire range of the virtual scene may be indicated by the operation prompt layer, and the action range of the skill in the virtual scene may be indicated by a color block displayed in the operation prompt layer.

The following further describes the touch point in S204. The touch point is a display element displayed in the operation prompt layer, and may be configured for indicating both the casting preview information of the target virtual item and touch operation information currently received. For example, the touch point may be configured for indicating an actual touch area of a current operating object (such as a player) in the display area. The touch point may also be configured for indicating an operation area corresponding to the actual touch area of the current operating object (such as the player) in the display area. In other words, the position of the touch point may be different from the position of the current operating object in the actual touch area in the display area.

In this implementation, the casting preview information of the target virtual item may be indicated by prompt elements that include the touch point and that are displayed in the operation prompt layer. The casting preview information of the target virtual item matching the stop position of the touch point may be displayed synchronously in the virtual scene while the prompt elements are displayed in the operation prompt layer. For example, when the target virtual item is a virtual shooting item, the aiming information of the target virtual item is synchronously previewed and displayed in the virtual scene (for example, a crosshair identifier is displayed). When the target virtual item is a virtual throw item, a throw trajectory curve of the target virtual item is synchronously previewed and displayed in the virtual scene. When the target virtual item is a virtual skill item, a skill action range of the target virtual item is synchronously previewed and displayed in the virtual scene.

In this implementation, in S204, when the touch point corresponding to the touch operation stops at the first stop position in the operation prompt layer, casting preview information of the target virtual item matching the first stop position is displayed in the first virtual scene picture may specifically mean that the casting preview information of the target virtual item is displayed at a display position matching the first stop position in the first virtual scene picture.

The following describes the first display area in S206. In response to the touch operation on the target control, a default display area of the operation prompt layer may be the first display area and corresponds to the first perspective of the current virtual object. When the touch point moves out of the first display area, the second perspective of the virtual object is correspondingly adjusted based on the stop position of the touch point, and the virtual scene picture from the second perspective is displayed. When the touch point moves in the first display area, the virtual object may be controlled to keep a current game perspective unchanged, that is, to keep displaying the picture of the virtual scene observed from the first perspective.

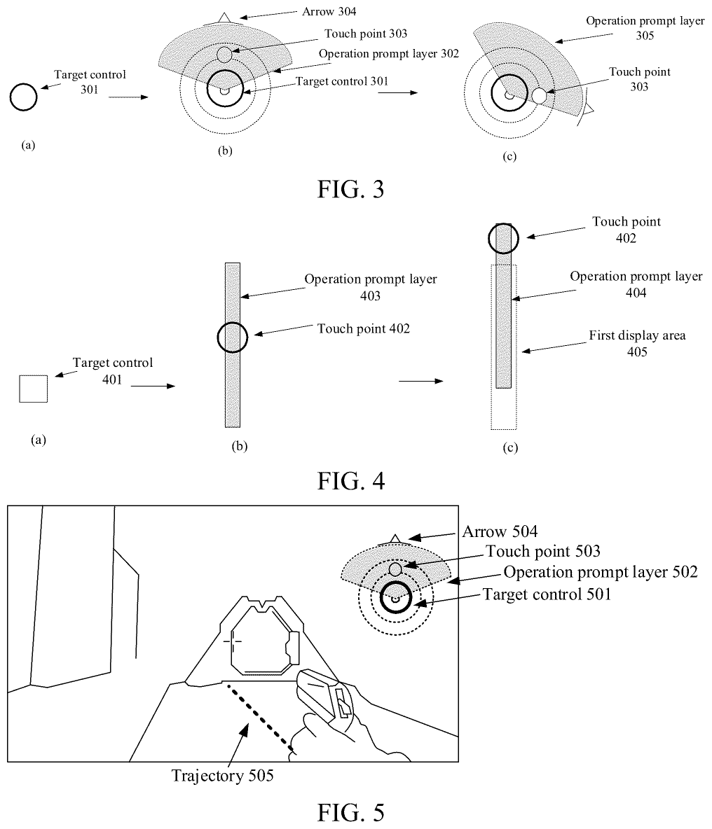

The following describes two display manners of the operation prompt layer with reference to FIG. 3 and FIG. 4.

A target control 301 shown in (a) of FIG. 3 is a display style of the target control. In response to a touch and hold operation on the target control 301, a control display pattern shown in (b) of FIG. 3 is displayed. To be specific, an operation prompt layer 302 is overlay-displayed on the target control 301, and a touch point 303 and an arrow 304 are displayed in the operation prompt layer. A sector area displayed in the operation prompt layer 302 currently displayed may be configured for indicating a virtual game scene observed by the current virtual object from the first perspective. An area in which the current operation prompt layer is located may be the first display area. The touch point 303 displayed in the operation prompt layer 302 may be configured for indicating a touch range of a touch signal currently received, that is, an actual touch position of a player. In addition, position information of the touch signal is configured for indicating a casting action range of a target virtual item corresponding to the target control 301. For example, when the target control 301 is a shooting item control, a current aiming direction is indicated to be straight ahead by a position of the current touch point 303 in an operation prompt area. When the target control 301 is a skill item control, an action range of the current skill is indicated to be a mapping area of an area of a display area of the touch point 303 in the operation prompt layer in the virtual game scene by the position of the current touch point 303 in the operation prompt area. Then, when the touch point moves out of the first display area, as shown in FIG. 3 (c), an operation prompt layer 305 located in a second display area is displayed based on the position of the touch point 303. A second perspective may be determined based on a deviation angle between the current touch point 303 and the first display area in which the operation prompt layer 302 is located, and a virtual scene picture matching the second perspective is displayed.

A target control 401 shown in (a) of FIG. 4 is another display style of the target control. In response to a touch and hold operation on the target control 401, a control display pattern shown in (b) of FIG. 4 is displayed. To be specific, the target control 401 is switched to display a touch point 402, and an operation prompt layer 403 in a slider style is overlay-displayed on the touch point 402. A rectangular range displayed in the operation prompt layer 403 currently displayed may be configured for indicating a virtual game scene observed by the current virtual object from the first perspective. An area in which the current operation prompt layer is located may be the first display area. The touch point 402 displayed in the operation prompt layer 403 may be configured for indicating a touch range of a touch signal currently received, that is, an actual touch position of a player. In addition, position information of the touch signal is configured for indicating a casting action range of a target virtual item corresponding to the target control 401. For example, when the target control 401 is a shooting item control, a current aiming direction is indicated to be straight ahead by a position of the current touch point 402 in the operation prompt area (that is a center of the slider). When the target control 401 is a skill item control, an action range of the current skill is indicated to be a mapping area of an arca of a display area of the touch point 402 in the operation prompt layer in the virtual game scene by the position of the current touch point 402 in the operation prompt area. In other words, the center of the slider may be configured for corresponding to a center position of the virtual scene. Then, when the touch point moves out of the first display area, as shown in (c) of FIG. 4, a second display area may be determined based on the position of the current touch point 402, and an operation prompt layer 404 is displayed in the second display area. A perspective size that needs to be adjusted is determined based on a deviation distance between the touch point 402 and a first display area 405 in which the operation prompt layer before adjustment is located and with reference to a mapping relationship between the deviation distance and a perspective adjustment, to determine a second perspective. A virtual scene picture matching the second perspective is displayed synchronously.

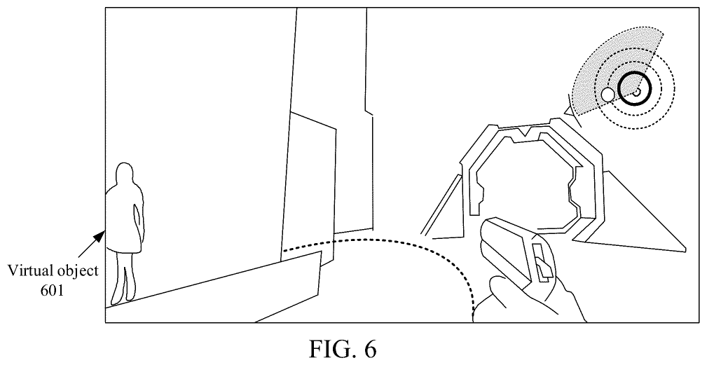

With reference to FIG. 5 and FIG. 6, the following describes an implementation in which the foregoing method in this disclosure is applied to a specific game scene. As shown in FIG. 5, a game interface currently displayed includes a scene picture observed by a target virtual object from a first perspective. In response to a touch and hold operation on a target control 501, an operation prompt layer 502 is overlay-displayed on the target control 501, and a touch point 503 and an arrow 504 are displayed in the operation prompt layer. A sector area displayed in the operation prompt layer 502 currently displayed may be configured for indicating a virtual game scene observed by the current virtual object from the first perspective. An area in which the current operation prompt layer is located may be the first display area. The touch point 503 displayed in the operation prompt layer 502 may be configured for indicating a touch range of a touch signal currently received, that is, an actual touch position of a player. In addition, position information of the touch signal is configured for indicating a casting action range of a target virtual item corresponding to the target control 501. As shown in FIG. 5, when the target control 501 is a shooting item control, a current aiming direction is indicated to be straight ahead by positions of the current touch point 503 and the arrow 504 in the operation prompt area, and a trajectory 505 is displayed in the virtual scene to indicate casting preview information of the current shooting item. Then, when the touch point moves out of the first display area, as shown in FIG. 6, and when a second perspective is determined based on the position of the touch point, a virtual scene picture matching the second perspective is displayed. As shown in FIG. 6, a virtual object 601 that cannot be originally observed from the first perspective is displayed in the second perspective.

In an aspect, a second display area is a display area matching (corresponding to) the second stop position, and may be specifically a display area of a preset range in which the second stop position is located.

In an aspect, a second virtual scene picture is a picture of the virtual scene observed by the target virtual object from the second perspective.

In the foregoing implementation of this disclosure, the target control is displayed in the display interface in which the first virtual scene picture is displayed, where the first virtual scene picture is the picture of the virtual scene observed by the target virtual object from the first perspective; the operation prompt layer matching the first perspective is overlay-displayed on the target control in response to the touch operation on the target control, where the operation prompt layer is configured for prompting the casting action range of the target virtual item usable by the target virtual object; and when it is determined that the touch point moves to the second stop position outside the first display area in which the operation prompt layer currently displayed is located, the operation prompt layer is adjusted to the second display area matching the second stop position, and the first virtual scene picture displayed in the display interface is adjusted to the second virtual scene picture, to display a special operation control configured to control the virtual object in the display interface. In this way, the operation prompt layer is displayed when the touch operation on the target control is detected, so that the casting action range of the virtual item is accurately controlled based on a position of the touch point in the operation prompt layer, and a function of quickly adjusting a game perspective is provided when the touch point is at a special position. Therefore, one operation can be provided to control the virtual object to cast the item and adjust the perspective of the virtual object simultaneously, thereby providing abundant control effects and improving control efficiency of the virtual object, to resolve the technical problem of low efficiency in the existing control method for a virtual object.

As an implementation, after the overlay-displaying the operation prompt layer matching the first perspective on the target control, the method further includes: in response to a first trigger operation on a first reference stop position in the operation prompt layer in the first display area, casting the target virtual item in the virtual scene presented by the first virtual scene picture based on first casting preview information matching the first reference stop position.

As an implementation, before the casting the target virtual item based on first casting preview information matching the first reference stop position, the method further includes: when it is determined that the first reference stop position is adjusted to a second reference stop position, in response to a second trigger operation on the second reference stop position, casting the target virtual item in the virtual scene presented by the first virtual scene picture based on second casting preview information matching the second reference stop position.

In this implementation, in response to the touch and hold operation on the target control, the operation prompt layer is overlay-displayed in the first display area including the target control. The player may continue to slide the touch point in the operation prompt layer to control the casting action range of the virtual item corresponding to the target control, synchronously adjust the casting preview information in the virtual scene, and cast the item based on the casting preview information when a release operation (such as a finger leaving a screen) is detected, the.

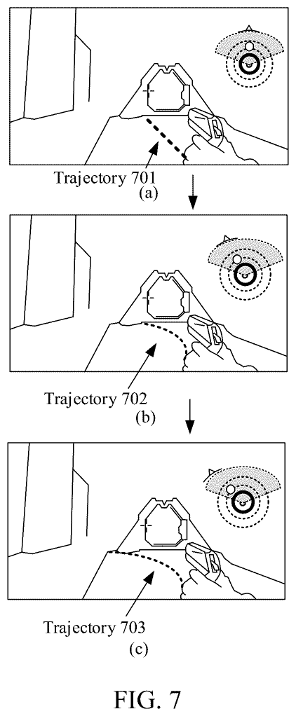

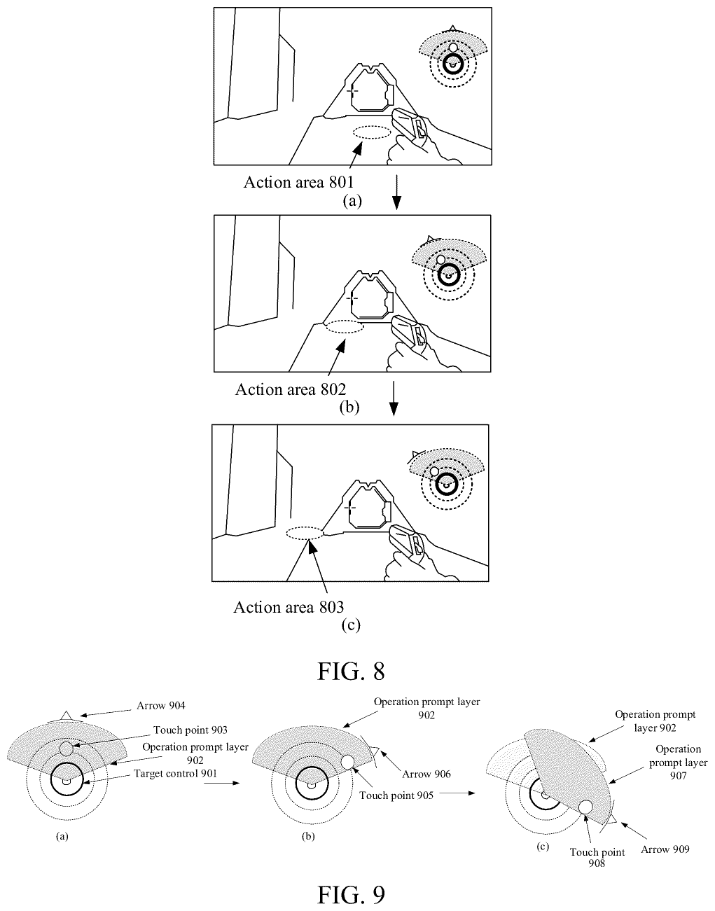

The following further describes the implementation of the foregoing method with reference to FIG. 7 and FIG. 8.

As shown in (a) of FIG. 7, when the target control is a skill item control configured to trigger a deflectable trajectory, in response to the touch and hold operation on the target control, the operation prompt layer is overlay-displayed on the target control, and the casting preview information, that is, a trajectory 701, is simultaneously displayed in the virtual scene. When the target control is initially triggered, the position of the touch point is a first position in (a) of FIG. 7 by default, that is, a center of the operation prompt layer, and a preview skill trajectory is a straight line in the virtual scene by default. Then, in response to that the touch point in the operation prompt layer moves to a second position, (b) of FIG. 7 is displayed. A trajectory 702 is controlled to be displayed in the virtual scene based on the second position of the touch point. In other words, the preview trajectory is controlled to synchronously deflect based on the position of the touch point. When the touch point continues to move, (b) of FIG. 7 is displayed. A trajectory 703 is controlled to be displayed in the virtual scene based on a third position of the touch point. In other words, the preview trajectory is controlled to synchronously deflect based on the position of the touch point. Finally, in response to a touch release operation at the third position, the skill item may be controlled to cast a skill effect based on the trajectory 703.

As shown in (a) of FIG. 8, when the target control is a skill item control configured to trigger an area action effect, in response to the touch and hold operation on the target control, the operation prompt layer is overlay-displayed on the target control, and the casting preview information, that is, an action area 801, is simultaneously displayed in the virtual scene. When the target control is initially triggered, the position of the touch point is a first position in (a) of FIG. 8 by default, that is, the center of the operation prompt layer, and a preview skill action area is a specific area in a center of a current visual field in the virtual scene by default. Then, in response to that the touch point in the operation prompt layer moves to a second position, as shown in (b) of FIG. 8 is displayed. An action area 802 is controlled to be displayed in the virtual scene based on the second position of the touch point. In other words, the preview action area is controlled to synchronously move based on the position of the touch point. When the touch point continues to move, (b) of FIG. 8 is displayed. An action area 803 is controlled to be displayed in the virtual scene based on a third position of the touch point. In other words, the preview action area is controlled to synchronously move based on the position of the touch point. Finally, in response to the touch release operation at the third position, the skill item may be controlled to cast a skill effect in the action area 803.

In the foregoing implementation of this disclosure, when it is determined that the first reference stop position is adjusted to the second reference stop position, in response to the second trigger operation on the second reference stop position, the target virtual item is cast in the virtual scene presented by the first virtual scene picture based on the second casting preview information matching the second reference stop position. When it is determined that the first reference stop position is adjusted to the second reference stop position, in response to the second trigger operation on the second reference stop position, the target virtual item is cast in the virtual scene presented by the first virtual scene picture based on the second casting preview information matching the second reference stop position. In this way, position information of the touch point in the operation prompt layer is received, so that the preview casting area of the virtual item can be adjusted in real time, thereby improving control efficiency of the virtual item.

In an implementation, after the overlay-displaying the operation prompt layer matching the first perspective on the target control, the method further includes: adjusting the display area in which the operation prompt layer displayed in the display interface is located synchronously with the touch point when the touch point moves.

In this implementation, when the touch point moves in the first display area, the preview information of the target virtual item is displayed based on the position information of the touch point, and the operation prompt layer is controlled to remain unchanged. When the touch point moves from inside of the first display area to outside of the first display area, the operation prompt layer is controlled to be adjusted synchronously based on the position of the touch point.

The following describes an adjustment manner of the operation prompt layer with reference to FIG. 9. As shown in (a) of FIG. 9, in response to a touch and hold operation on a target control 901, an operation prompt layer 902 is displayed on the target control 901, and a touch point 903 and an arrow 904 are displayed to indicate preview trajectory information of a current target virtual item. Then, in response to a movement operation of the touch point 903, when the touch point 903 moves to a right edge of the operation prompt layer 902, a control pattern shown in (b) of FIG. 9 is displayed, and a touch point 905 located at a right edge of a first display area and a corresponding arrow 906 are displayed. Then, in response to that the touch point 905 continues to move to a second position outside the first display area, (c) of FIG. 9 is displayed. That is, a touch point 908 located at the second position and a corresponding arrow 909 are displayed, and a synchronously adjusted operation prompt layer 907 is simultaneously displayed. As shown in (c) of FIG. 9, the operation prompt layer 907 is a layer obtained by rotating the original operation prompt layer 902 based on the touch point 908. An area in which the current operation prompt layer 907 is located may be a second display area. Further, during the touch point 905 moving to the position of the touch point 908, the operation prompt layer may be rotated and updated in real time based on a real-time position of the touch point, and an updated operation prompt layer is displayed in real time. Because the operation prompt layer may be configured for indicating a current perspective of a target virtual object, a game perspective of the current target virtual object may be synchronously adjusted through a movement of the touch point.

Further, because the position of the operation prompt layer may be synchronously adjusted based on the position of the touch point, a relative position between the touch point and the operation prompt layer is always in a stable state, so that when the position of the operation prompt layer is synchronously adjusted based on the position of the touch point, item casting preview information indicated by the touch point can remain unchanged. For example, in (b) of FIG. 9, the touch point 905 is located at an edge position of the operation prompt layer 902, which may be used to indicate that the preview trajectory of the current target virtual item is deflected 60 degrees to the right. In (c) of FIG. 9, the touch point 908 is also located at an edge position of the operation prompt layer 907, which may also be used to indicate that the preview trajectory of the current target virtual item is deflected 60 degrees to the right relative to a straight-ahead direction of the current perspective.

In the foregoing implementation of this disclosure, the display area in which the operation prompt layer displayed in the display interface is located is adjusted synchronously with the touch point when the touch point moves, so that the operation prompt layer and the game perspective of the target virtual object are controlled to be adjusted synchronously based on the position of the touch point, to implement quick linkage adjustments of the casting preview information of the target virtual item and the game perspective of the target virtual object through a linkage relationship between the operation prompt layer and the touch point.

In an implementation, after the displaying the first virtual scene picture in the display interface to a second virtual scene picture, the method further includes: in response to a third trigger operation on a third reference stop position in the operation prompt layer in the second display area, casting the target virtual item in the virtual scene presented by the second virtual scene picture based on third casting preview information matching the third reference stop position.

In this implementation, after the first virtual scene picture displayed in the display interface is adjusted to the second virtual scene picture based on a relative position relationship between the touch point and the first display area, the touch point may be continuously controlled to move in the operation prompt layer displayed in the second display arca, and the casting preview information is synchronously adjusted based on the position of the touch point. When the trigger operation is detected, the target virtual item is cast in the second virtual scene based on the latest casting preview information.

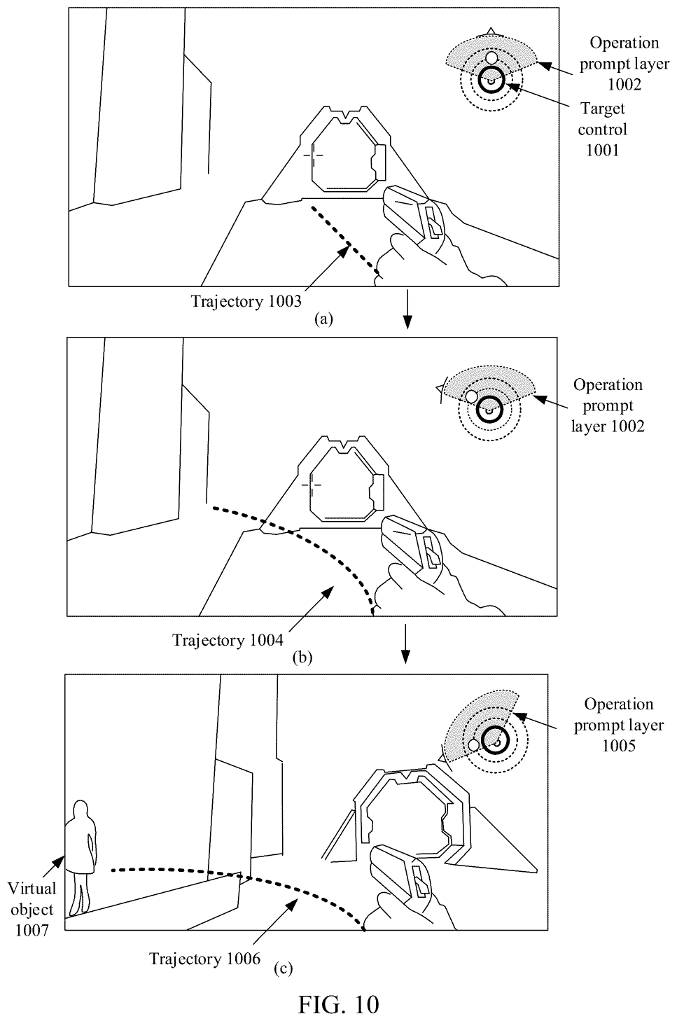

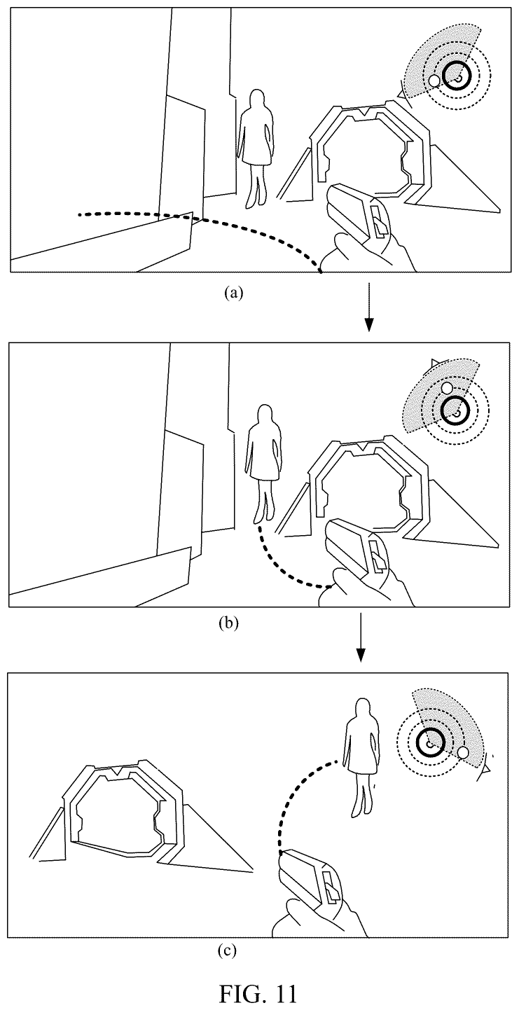

The following further describes the foregoing method with reference to FIG. 10. As shown in (a) of FIG. 10, in response to a trigger operation on a target control 1001, an operation prompt layer 1002 is overlay-displayed on the target control 1001, and a default preview trajectory of a virtual item is simultaneously displayed in the first virtual scene picture, that is, a trajectory 1003 is displayed. An area in which the current operation prompt layer 1002 is located is the first display area. Then, in response to a movement operation of a touch point in the operation prompt layer 1002, the preview trajectory is controlled to deflect synchronously. As shown in (b) of FIG. 10, when the touch point is located at a left edge of the operation prompt layer 1002, a trajectory 1004 is controlled to be displayed. In this case, a deviation angle of the current trajectory reaches a maximum value. Then, still in response to the movement of the touch point, when the touch point moves out of the first display area in which the operation prompt layer 1002 is located, the operation prompt layer is controlled to be rotated synchronously based on the position of the touch point. A game perspective of a target virtual object is synchronously rotated based on a rotation angle of the operation prompt layer, and a virtual game scene from the current game perspective is displayed. As shown in (c) of FIG. 10, when the touch point displayed in the operation prompt layer moves to a position shown in (c) of FIG. 10, an operation prompt layer 1005 matching the current touch point position is controlled to be displayed, and a virtual scene picture corresponding to the operation prompt layer 1005 and a virtual object 1007 appearing in the picture are displayed. During adjustment of the perspective, a trajectory 1006 keeps a maximum deviation angle and deflects synchronously with the game perspective, so that an end point of a casting trajectory of the current virtual item, that is, a position of the virtual object 1007, can be determined based on the preview trajectory information. Further, the target control 1001 is released from the current perspective and the preview trajectory to control the virtual item to hit the virtual object 1007 based on the trajectory 1006.

In the foregoing implementation of this disclosure, in response to a third trigger operation on a third reference stop position in the operation prompt layer in a second display arca, a target virtual item is cast in a virtual scene presented by a second virtual scene picture based on third cast preview information matching the third reference stop position, so that a flexible and efficient control manner for a control is provided. A player may call out the operation prompt layer by touching and holding a skill control, and control a skill trajectory and the game perspective based on the touch point in the operation prompt layer. In this way, a complex operation caused by controlling the perspective and an action range respectively through two different touch operations is avoid, thereby improving control efficiency of the virtual object and resolving the technical problem of low efficiency in the existing control method for a virtual object.

As an example, after the target virtual item is cast, the method further includes: hiding the operation prompt layer.

In this implementation, the operation prompt layer may be called out by touching and holding the target control, and the operation prompt layer may be hidden when the target control is released, to avoid covering another display element in a display interface due to long-time display of the operation prompt layer. The operation prompt area is controlled to be displayed again when the target control is triggered, thereby improving display efficiency of the operation prompt layer.

In an implementation, after the overlay-displaying the operation prompt layer matching the first perspective on the target control, the method further includes: hiding the operation prompt layer when it is determined that the touch point moves to a target operation position configured for the operation prompt layer.

In this implementation, after the operation prompt layer is called out by touching and holding the target control, the touch point may be moved to the target operation position, and the operation prompt layer is hidden, to cancel the skill trigger operation. For example, the touch point may be moved to a center point of the skill control, or to an operation position that is away from the target operation position in the operation prompt layer in the game operation interface, to cancel the skill operation.

In the foregoing implementation of this disclosure, the operation prompt layer is hidden when it is determined that the touch point moves to the target operation position configured for the operation prompt layer, to provide a cancellation operation after the control is triggered, to avoid wrong skill release due to a mistouch operation, thereby improving control accuracy of the virtual item.

The following describes a complete implementation with reference to FIG. 10 and FIG. 11.

When releasing a skill with a ballistic trajectory, a game player may selectively release the skill by using a virtual joystick of a skill button. After pressing the joystick, a finger moves up, down, left, and right without releasing. In this case, a preset direction of the ballistic trajectory of the skill may be controlled, and the skill may be released after the finger releases. As shown in (a) of FIG. 10 and (b) of FIG. 10, when pre-releasing the skill (that is, when touch and holding a skill control to display an operation prompt layer), the player may select whether a pre-release trajectory of the skill turns left or right by sliding the finger in left and right directions. However, in this case, a sliding range is limited to a marked sector range of the virtual joystick. The sector range is about 120 degrees, and the finger may slide freely in the area to control a release trajectory of the skill. In this case, a perspective of the player does not change under the control of the virtual joystick.

When the player is attacked by an enemy outside a visual field in this case, a first reaction is to hit the enemy outside the visual field by using the current pre-release skill, and therefore the current visual field needs to be adjusted. The skill is still in a pre-release stage, and in this case, the player may continue to control a change of the visual field thereof by touching and sliding the virtual joystick. As shown in (c) of FIG. 10, the player rotates the finger to the left to an area in which the enemy is located. When a touch goes beyond a boundary of the sector area that originally controls the skill trajectory, the visual field of the player is adjusted, and the sector area is also rotated to change synchronously in this case. In other words, in this case, the visual field of the player is adjusted after going beyond a boundary of the skill trajectory, the skill trajectory is a pre-release effect of turning left, and the enemy is also inside the current visual field. Because the sector trajectory adjustment area keeps rotating with the visual field, in this case, the player may continue to slide right to control a trajectory curve without affecting the adjustment of the visual field, thereby achieving a precise hit effect.

For example, as shown in (a) of FIG. 11, in this case, the enemy is close to the right side of the visual field area, and the skill trajectory cannot completely hit the enemy, so that the player needs to move the virtual joystick to the right, and the skill trajectory also turns right, but the visual field does not change. Until the skill trajectory overlaps with the enemy as shown in (b) of FIG. 11, if the virtual joystick is released in this case, the skill can be released directly to hit the enemy and complete an attack operation.

If the enemy player is still adjusting the position, when the visual field goes beyond a visual field range adjusted by the player, the player may still continue to slide the virtual joystick, and goes beyond the boundary of the skill trajectory area to adjust the visual field. As shown in (c) of FIG. 11, in this case, the enemy moves to the visual field area at the right side, and the player needs to turn right quickly. Therefore, the player may continue to control the skill virtual joystick to slide right quickly, that is, goes beyond the trajectory control boundary after quickly deflecting the skill trajectory to the right. In this case, the player turns right until the visual field deflects to the visual field area in which the enemy is located, and releases the finger to release the skill to complete the attack operation.

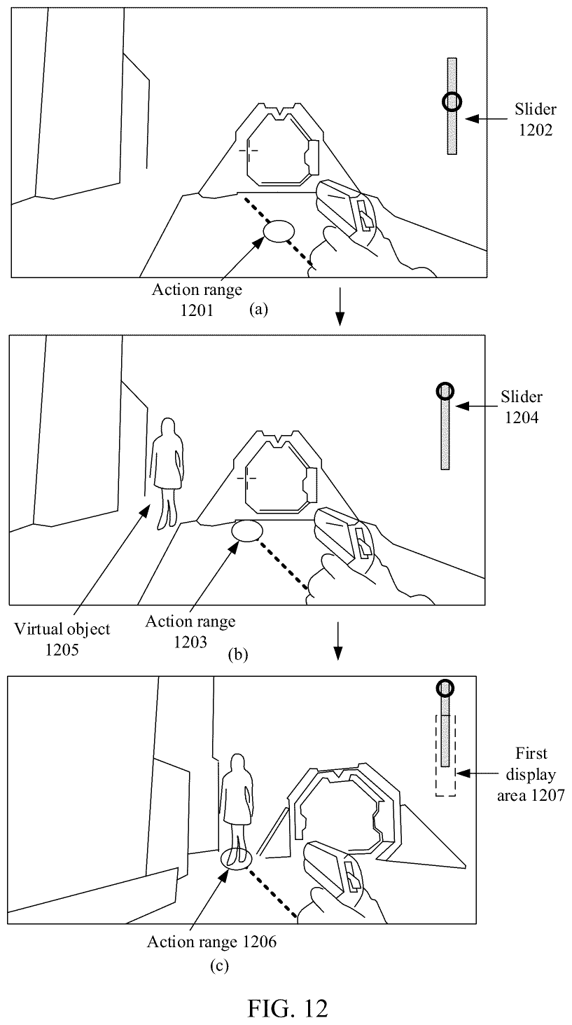

The following describes another complete implementation with reference to FIG. 12. As shown in (a) of FIG. 12, in response to a touch operation on a target control, a slider 1202 is displayed for adjusting a throw action range of a current throw item. In response to the touch operation on the target control, a touch point is located on a middle portion of the slider 1202 by default, and a preview action range 1201 in a virtual scene is located at a midpoint position of a trajectory by default. Then, as shown in (b) of FIG. 12, in response to a movement of a touch point on a slider 1204, when the touch point moves to a top of the slider 1204, a preview action range of the throw item in the virtual scene is controlled to be displayed at a top position of a default throw trajectory, that is, as shown in (b) of FIG. 12, an action range 1203 is displayed. Assuming that a target virtual object is attacked by a virtual object 1205 in this case, the action range needs to be further adjusted to fight back against the virtual object 1205. However, because the current throw item only supports adjusting a distance of the action range on the default throw trajectory, a game perspective of the target virtual object needs to be adjusted, to fight back against the virtual object in the action range. Further, in response to an upward movement of the touch point on the slider, as shown in (c) of FIG. 12, when the touch point moves to a target position outside a first display area 1207 in which the slider 1204 is located, a perspective adjustment angle is determined based on a distance difference between the target position and the first display area, and a second game scene is displayed based on the perspective adjustment angle. The trajectory of the throw item is controlled to be adjusted synchronously with the arrangement of the perspective, so that an action range 1206 can precisely fall at the position of the virtual object 1205, to fight back against the enemy virtual object.

In the foregoing implementation of this disclosure, the target control is displayed in the display interface in which the first virtual scene picture is displayed, where the first virtual scene picture is the picture of the virtual scene observed by the target virtual object from the first perspective; the operation prompt layer matching the first perspective is overlay-displayed on the target control in response to the touch operation on the target control, where the operation prompt layer is configured for prompting the casting action range of the target virtual item usable by the target virtual object; when it is determined that the touch point moves to the second stop position outside the first display area in which the operation prompt layer currently displayed is located, the operation prompt layer is adjusted to the second display area matching the second stop position, and the first virtual scene picture displayed in the display interface is adjusted to the second virtual scene picture, to display a special operation control configured to control the virtual object in the display interface. In this way, the operation prompt layer is displayed when the touch operation on the target control is detected, so that the casting action range of the virtual item is accurately controlled based on a position of the touch point in the operation prompt layer, and a function of quickly adjusting a game perspective is provided when the touch point is at a special position. Therefore, one operation can be provided to control the virtual object to cast the item and adjust the perspective of the virtual object simultaneously, thereby providing abundant control effects and improving control efficiency of the virtual object, to resolve the technical problem of low efficiency in the existing control method for a virtual object.

In an implementation, the overlay-displaying an operation prompt layer matching the first perspective on the target control in response to the touch operation on the target control includes the following operations.

S1: Obtain touch position information of the touch operation.

S2: Determine a first deviation angle based on the touch position information and position information of an area baseline of the first display area, where the area baseline is a center line of the first display area.

S3: Display the touch point corresponding to the touch operation in the operation prompt layer based on the first deviation angle.

In this implementation, an actual touch position of the received touch operation may be different from a display position of the touch point. Specifically, the display position of the touch point in the operation prompt layer may be determined based on the deviation angle between the actual position of the touch operation and the baseline of the operation prompt layer.

In an implementation, during the displaying the touch point corresponding to the touch operation in the operation prompt layer based on the first deviation angle, the method further includes: when the touch point stops at a stop position in the operation prompt layer, updating the casting preview information of the target virtual item in the first virtual scene picture based on the first deviation angle.

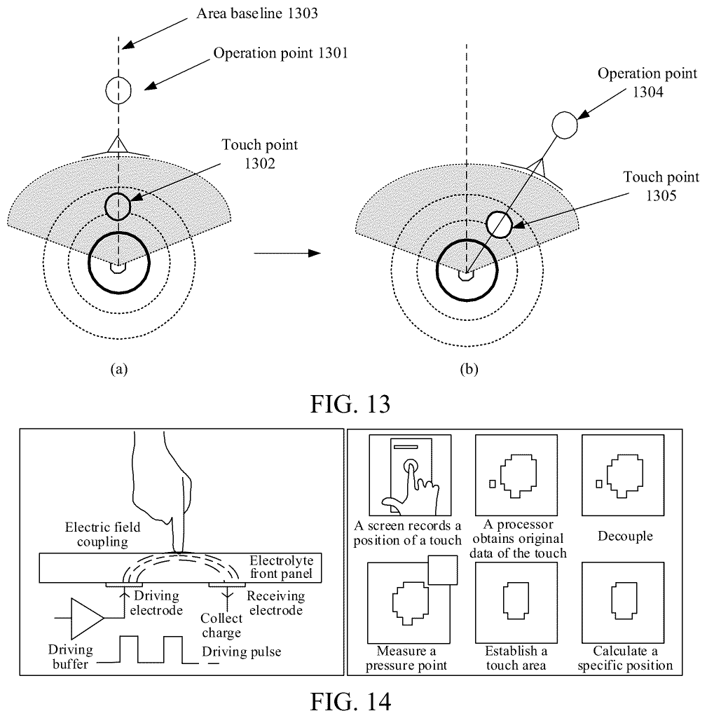

The following describes the foregoing manner of displaying the touch point with reference to FIG. 13. As shown in (a) of FIG. 13, when a current touch operation point is located at a position of an operation point 1301, it is determined that an included angle between a line connecting the operation point to a center point of a target control and an area baseline 1303 is 0 degrees, and then a touch point 1302 is displayed at a position at an angle corresponding to a second circle in an operation prompt layer, to indicate that a trajectory deviation angle of a current target virtual item is 0 degrees. Then, as shown in (b) of FIG. 13, when the current touch operation point is located at a position of an operation point 1304, it is determined that an included angle between the line connecting the operation point to the center point of the target control and the area baseline is 30 degrees, and then a touch point 1305 is displayed at a position at an angle of 30 degrees corresponding to the second circle in the operation prompt layer, to indicate that a trajectory deviation angle of the current target virtual item is 30 degrees to the right.

Because a display area in mobile games is limited, if a movement control operation is only provided in the operation prompt area, an adjustment error is likely to occur due to a small control area. In this implementation, an actual touch range that can be controlled and adjusted is expanded to an area outside the operation prompt area, so that precise angle adjustment can be implemented through a large touch operation.

The following describes a principle of a screen inducting a movement trajectory of a finger with reference to FIG. 14. As shown in FIG. 14, electrodes are plated on four sides of a touchscreen, to form a low-voltage alternating electric field. When a finger touches the screen, a coupling capacitor is formed between the finger and a conductor layer because a human body conducts electricity. Currents emitted by the electrodes on the four sides flow to a contact, a signal is generated between an inner layer and an outer layer of the touchscreen through a metal oxide in the middle, and a central processing unit (CPU) obtains a coordinate point through the received signal. An abscissa of the mobile phone is an X axis, and an ordinate is a Y axis, so that the screen can induct the trajectory and the route of finger sliding.

In the foregoing implementation of this disclosure, the touch position information of the touch operation is obtained. The first deviation angle is determined based on the touch position information and the position information of the area baseline of the first display arca, where the area baseline is the center line of the first display area. Through the manner of displaying the touch point corresponding to the touch operation in the operation prompt layer based on the first deviation angle, when the actual operation control point is not located in the operation prompt layer, the position of the touch point is displayed at a corresponding position in the operation prompt layer, thereby implementing precise adjustment of a skill deviation angle and a game perspective based on the position of the touch point.

In an implementation, after the determining a first deviation angle based on the touch position information and position information of an area baseline of the first display area, the method further includes the following operations.

S1: Determine that the touch point moves to a stop position outside the first display area when the first deviation angle is greater than a target angle threshold.

S2: Use a difference between the first deviation angle and the target angle threshold as a perspective adjustment parameter.

S3: Determine the second perspective based on the perspective adjustment parameter, and display the second virtual scene picture observed by the target virtual object from the second perspective.

In an implementation, after the using a difference between the first deviation angle and the target angle threshold as a perspective adjustment parameter, the method further includes the following operations.

S1: Rotate the operation prompt layer matching the first perspective based on the perspective adjustment parameter, and determine a second display area matching the stop position.

S2: Display the operation prompt layer in the second display area.

S3: Determine a second deviation angle based on the touch position information and position information of an area baseline of the second display area.

S4: Display the touch point corresponding to the touch operation in the operation prompt layer based on the second deviation angle.

S5: Update the casting preview information of the target virtual item in the second virtual scene picture based on the second deviation angle when the touch point stops at the stop position in the operation prompt layer.

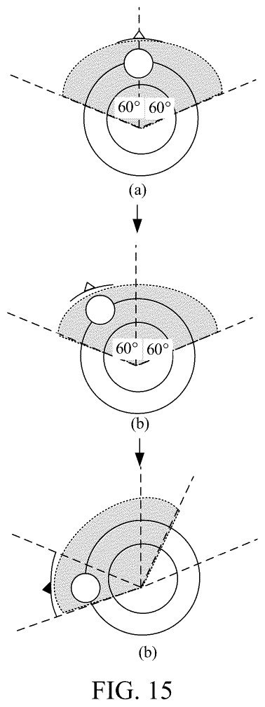

The following further describes a principle of determining and adjusting a trajectory or a perspective in a joystick area with reference to FIG. 15. In this implementation, when a lens rotation and a skill trajectory selection are simultaneously processed, a player behavior is determined by touching a moving coordinate included angle. A first display position (X1, Y1) and a current rotation angle of a virtual camera are obtained based on a touchscreen. The current rotation angle of the virtual camera is a quaternion, and the quaternion may be regarded as a four-dimensional vector used to represent a rotation of an object in a space and the like. As shown in (a) of FIG. 15, in this case, using an angle a of the current rotation on a horizontal plane as a base, rotation ranges of 60 degrees on both left and right rotation boundaries are recorded. In other words, a rotation range of 120 degrees on the horizontal plane is recorded, and is represented as a plane sector area displayed in a terminal. As shown in (b) of FIG. 15, when the touch movement of the terminal is detected, the behavior is determined. If a change in a camera included angle corresponding to a display position obtained in this case is less than 60 degrees, a combat module is triggered correspondingly, that is, a trajectory of a pre-release skill deflects. As shown in (c) of FIG. 15, if the camera included angle corresponding to the display position obtained in this case exceeds 60 degrees, it is first determined that the skill trajectory deflects in the area, and then the virtual camera deflects by more than 60 degrees to the left or right. If the virtual camera deflects by more than 60 degrees to the left, a rotation angle after deviation is recorded as a left boundary of a sector, and a 120-degree area on the right of the new left boundary is used as a rightward skill trajectory deviation area. If in the new skill trajectory deviation area, the virtual camera deflects by more than 120 to the right, the lens is controlled to deflect. Similarly, if the virtual camera deflects by more than 60 degrees to the right, the rotation angle after deviation is recorded as a right boundary of a new sector, and a 120-degree area on the left of the right boundary of the new sector is used as a leftward skill trajectory deviation area. If the virtual camera deflects by more than 120 to the left, it is determined that the lens is controlled to deflect. Through this cycle, an effect of synchronously controlling the camera lens and the skill trajectory at a horizontal angle is implemented.

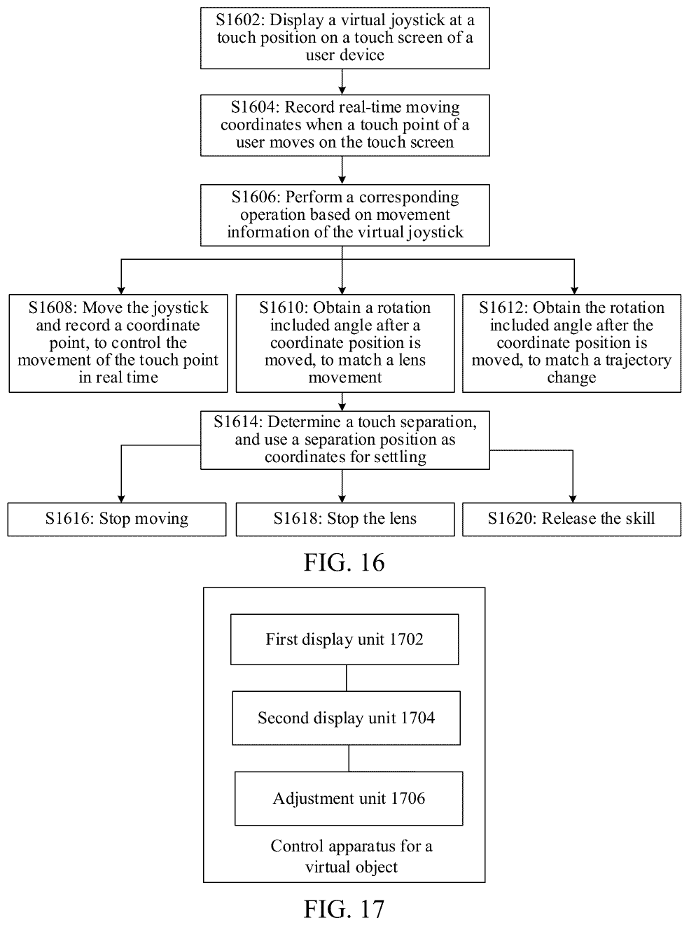

The following describes an entire adjustment manner for a trajectory and a perspective in this implementation with reference to FIG. 16.

As shown in FIG. 16, first, when a touch and hold operation on a target control is detected, S1602 is performed to display a virtual joystick at a touch position on a touchscreen of a user device. Then, S1604 is performed to record real-time moving coordinates when a touch point of a user on the touchscreen moves. When a player taps and touches a key on the touchscreen of the device, it is determined that a first display position of a graphical user interface is obtained and is used as an origin of coordinates (X1, Y1). The position is affected by a hot range of a skill key.

Then S1606 is performed to perform a corresponding operation based on movement information of the virtual joystick.

The control for the virtual joystick may distinguish different behavior modules, usually including a motion module, a lens module, a combat module, and the like.

The motion module mainly performs S1608 to move the joystick and record a coordinate point, to control the movement of the touch point in real time. Real-time control coordinates (Xn, Yn) are obtained through a touch and movement of a finger of the player, and a relative direction and distance between (X1, Y1) and (Xn, Yn) are calculated. A joystick command of simulating a game handle is sent to a system, to control a multifaceted movement direction of a character or a trajectory of a pre-release skill.

The lens module is mainly configured to perform S1610 to obtain a rotation included angle after a coordinate position is moved, to match a lens movement. When the player touches a game interface, a current rotation angle of a virtual camera is obtained to match a current coordinate position. A real-time coordinate position is recorded based on the touch and movement of the finger, to obtain a corresponding rotation included angle, to match a lens shake;

The combat module is mainly configured to perform S1612 to obtain the rotation included angle after the coordinate position is moved, to match a trajectory change.

In a determining operation, S1614 is mainly performed to determine a touch separation, and use a separation position as coordinates for settling. To be specific, the touch separation between the finger and the game interface is detected, and the separation position is used as final coordinates to settle a behavior of each module, that is, the player stops moving, stops turning the lens, or releases the skill.

After the determining operation ends, S1616 to S1620 are mainly performed to stop moving, stop the lens, and cast the skill.

In the foregoing aspect of this disclosure, when an operation skill of the player has a lens control requirement and a preselected trajectory control requirement, an operation of simultaneously controlling the lens and the trajectory can be implemented by determining an included angle range on a horizontal plane or a vertical plane. In addition, the operation perfectly fits a behavior line of the player. A large range of displacement of the virtual joystick can control an angle of the camera of the player, and a small range of displacement can control a precise effect of skill release, achieving two goals with one operation. The player obtains more precise and convenient operation manners in actual combat experience, so that complexity and richness of the skill operation of this type of game are improved, and operation experience of the skill release of this type is optimized, to better help the player feel a convenient effect similar to that of keyboard and mouse operations on a mobile terminal.

For ease of description, the foregoing method examples are described as combinations of a series of actions. However, a person skilled in the art should know that, this disclosure is not limited to any described order of the actions, because some operations may be performed in another order or simultaneously according to this disclosure.

According to another aspect of this disclosure, a control apparatus for a virtual object configured to perform the foregoing control method for a virtual object is further provided. As shown in FIG. 17, the apparatus includes a first display unit 1702, a second display unit 1704, and an adjustment unit 1706.

The first display unit 1702 is configured to display a target control in a display interface in which a first virtual scene picture is displayed, the first virtual scene picture being a picture of a virtual scene observed by a target virtual object from a first perspective.

The second display unit 1704 is configured to overlay-display an operation prompt layer matching the first perspective on the target control in response to a touch operation on the target control, the operation prompt layer being configured for prompting a casting action range of a target virtual item usable by the target virtual object, and when a touch point corresponding to the touch operation stops at a first stop position in the operation prompt layer, casting preview information of the target virtual item matching the first stop position being displayed in the first virtual scene picture.

The adjustment unit 1706 is configured to: when it is determined that the touch point moves to a second stop position outside a first display area in which the operation prompt layer currently displayed is located, adjust the operation prompt layer to a second display arca matching the second stop position, and adjust the first virtual scene picture displayed in the display interface to a second virtual scene picture, the second virtual scene picture being a picture of a virtual scene observed by the target virtual object from a second perspective.

In an aspect, for implemented by the foregoing unit modules, reference may be made to the foregoing methods, and details are not described herein again.

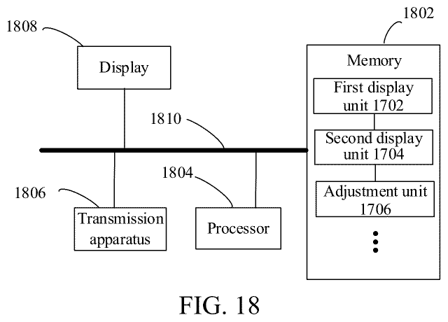

According to still another aspect of this disclosure, an electronic device configured to perform the foregoing control method for a virtual object is further provided. The electronic device may be a terminal device or a server shown in FIG. 18. In this disclosure, the electronic device being a terminal device is used as an example for description. As shown in FIG. 18, the electronic device includes a memory 1802 and a processor 1804. The memory 1802 has a computer program stored therein. Processing circuitry, such as the processor 1804 is configured to perform operations in any one of the foregoing method embodiments through the computer program.

In an aspect, the electronic device may be located in at least one of a plurality of network devices in a computer network.

In an aspect, the processor may be configured to perform the following operations through the computer program.

S1: Display a target control in a display interface in which a first virtual scene picture is displayed, the first virtual scene picture being a picture of a virtual scene observed by a target virtual object from a first perspective.

S2: Overlay-display an operation prompt layer matching the first perspective on the target control in response to a touch operation on the target control, the operation prompt layer being configured for prompting a casting action range of a target virtual item usable by the target virtual object, and when a touch point corresponding to the touch operation stops at a first stop position in the operation prompt layer, casting preview information of the target virtual item matching the first stop position being displayed in the first virtual scene picture.

S3: When it is determined that the touch point moves to a second stop position outside a first display area in which the operation prompt layer currently displayed is located, adjust the operation prompt layer to a second display area matching the second stop position, and adjust the first virtual scene picture displayed in the display interface to a second virtual scene picture, the second virtual scene picture being a picture of a virtual scene observed by the target virtual object from a second perspective.

In other aspects, a person of ordinary skill in the art may understand that, the structure shown in FIG. 18 is only an example. The electronic device may be a terminal device such as a smartphone (for example, an Android mobile phone or an IOS mobile phone), a tablet computer, a palmtop computer, a mobile Internet device (MID), or a PAD. FIG. 18 does not limit the structure of the electronic device. For example, the electronic device may further include more or fewer components (such as a network interface) than those shown in FIG. 18, or has a configuration different from that shown in FIG. 18.

The memory 1802 may be configured to store a software program and a module, for example, program instructions/modules corresponding to the control method and apparatus for a virtual object in the aspects of this disclosure. The processor 1804 runs the software program and the module stored in the memory 1802, to implement various functional applications and data processing, that is, implement the foregoing control method for a virtual object. The memory 1802 may include a high speed random access memory, such as a non-transitory computer-readable storage medium and may also include a non-volatile memory, for example, one or more magnetic storage apparatuses, a flash memory, or another non-volatile solid-state memory. In an aspect, the memory 1802 may further include memories remotely disposed relative to the processor 1804, and the remote memories may be connected to a terminal through a network. Examples of the network include, but are not limited to, the Internet, an intranet, a local area network, a mobile communication network, and a combination thereof. The memory 1802 may be specifically configured to, but is not limited to, store information such as elements in a scene picture and control information for a virtual object. For example, as shown in FIG. 18, the memory 1802 may include, but is not limited to, the first display unit 1702, the second display unit 1704, and the adjustment unit 1706 that are in the foregoing control apparatus for a virtual object. In addition, the memory 1802 may include, but is not limited to, another module unit in the foregoing control apparatus for a virtual object, and details are not described in this example.

In an aspect, a transmission apparatus 1806 is configured to receive or send data through a network. Specific examples of the network may include a wired network and a wireless network. In an example, the transmission apparatus 1806 includes a network interface controller (NIC), and the network interface controller may be connected to another network device and a router through a network cable, to communicate with the Internet or a local area network. In an example, the transmission apparatus 1806 is a radio frequency (RF) module, and is configured to communicate with the Internet in a wireless manner.

In addition, the foregoing electronic device further includes: a display 1808, configured to display a virtual scene in an interface; and a connection bus 1810, configured to connect module parts in the electronic device.

In another aspect, the foregoing terminal device or server may be a node in a distributed system. The distributed system may be a blockchain system, and the blockchain system may be a distributed system formed by connecting a plurality of nodes in a form of network communication. The nodes may form a peer to peer (P2P) network, and any form of computing device, for example, the electronic device such as the server or the terminal, may become a node in the blockchain system by joining the peer to peer network.

According to an aspect of this disclosure, a computer program product is provided. The computer program product includes computer programs/instructions, and the computer programs/instructions include program code configured for performing the method shown in the flowchart. In such an aspect, the computer program may be downloaded and installed from a network through a communication part, and/or installed from a removable medium. When the computer program is executed by a central processing unit, functions provided in this disclosure are executed.

Sequence numbers of the foregoing aspects of this disclosure are merely for description purposes and do not indicate the preference of the aspects.

According to an aspect of this disclosure, a computer-readable storage medium is provided. A processor of a computer device reads computer instructions from the computer-readable storage medium. The processor executes the computer instructions to enable the computer device to perform the foregoing control method for a virtual object.

In this aspect, the computer-readable storage medium may be configured to store a computer program configured to perform the following operations.

S1: Display a target control in a display interface in which a first virtual scene picture is displayed, the first virtual scene picture being a picture of a virtual scene observed by a target virtual object from a first perspective.

S2: Overlay-display an operation prompt layer matching the first perspective on the target control in response to a touch operation on the target control, the operation prompt layer being configured for prompting a casting action range of a target virtual item usable by the target virtual object, and when a touch point corresponding to the touch operation stops at a first stop position in the operation prompt layer, casting preview information of the target virtual item matching the first stop position being displayed in the first virtual scene picture.

S3: When it is determined that the touch point moves to a second stop position outside a first display area in which the operation prompt layer currently displayed is located, adjust the operation prompt layer to a second display area matching the second stop position, and adjust the first virtual scene picture displayed in the display interface to a second virtual scene picture, the second virtual scene picture being a picture of a virtual scene observed by the target virtual object from a second perspective.

In an aspect, a person of ordinary skill in the art may understand that all or part of the operations of the methods in the foregoing aspects may be implemented by a program instructing hardware relevant to a terminal device. The program may be stored in a non-transitory computer-readable storage medium, and the storage medium may include: a flash drive, a read-only memory (ROM), a random access memory (RAM), a magnetic disk, an optical disc, and the like.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

When the integrated unit in the foregoing aspects is implemented in a form of a software functional unit and sold or used as an independent product, the integrated unit may be stored in the foregoing computer-readable storage medium. Based on such an understanding, one or more of the technical solutions of this disclosure may be implemented in a form of a software product. The computer software product is stored in a storage medium and includes several instructions used to enable one or more computer devices (which may be a personal computer, a server, a network device, or the like) to perform all or some of the operations of the methods described in aspects of this disclosure.

In the foregoing aspects of this disclosure, descriptions of the aspects have different emphases. For a part that is not described in detail in one aspect, refer to related descriptions in other aspects.

In the several aspects provided in this disclosure, the disclosed client may be implemented in another manner. For example, the unit division is merely logical function division and may have other division manners in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic or other forms.

The units described as separate parts may or may not be physically separate, and parts displayed as units may or may not be physical units, may be located in one position, or may be distributed on a plurality of network units. A part of or all of the units may be selected based on an actual need to achieve the objectives of the solutions of the aspects.

In addition, functional units in aspects of this disclosure may be integrated into one processing unit, or each of the units may exist alone physically, or two or more units are integrated into one unit. The integrated unit may be implemented in a form of hardware, or may be implemented in a form of a software function unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely examples of implementations of this disclosure. A person of ordinary skill in the art may further make several improvements and modifications without departing from the principle of this disclosure. These improvements and modifications shall fall within the protection scope of this disclosure.

What is claimed is:

1. A control method for a virtual object, the method comprising:
displaying a target control in a display interface of a first virtual scene, the first virtual scene corresponding to a first perspective of a target virtual object;
displaying an operation prompt based on the first perspective on the target control and a touch operation, the operation prompt being configured to display a casting action range of a target virtual item;
displaying casting preview information of the target virtual item in the first virtual scene when the touch operation stops at a first stop position in the operation prompt; and
adjusting the first virtual scene displayed in the display interface to a second virtual scene corresponding to a second perspective of the target virtual object.

2. The method according to claim 1, further comprising:
adjusting a display area in which the operation prompt displayed in the display interface with a touch point when the touch point moves.

3. The method according to claim 1, further comprising:
based on a first trigger operation on a first reference stop position in the operation prompt in a first display area, casting the target virtual item in the first virtual scene based on first casting preview information matching the first reference stop position.

4. The method according to claim 3, further comprising:
when the first reference stop position is adjusted to a second reference stop position, based on a second trigger operation on the second reference stop position, casting the target virtual item in the first virtual scene based on second casting preview information matching the second reference stop position.

5. The method according to claim 4, further comprising:
based on a third trigger operation on a third reference stop position in the operation prompt in a second display area, casting the target virtual item in the second virtual scene based on third casting preview information matching the third reference stop position.

6. The method according to claim 3, further comprising:
hiding the operation prompt.

7. The method according to claim 1, further comprising:
hiding the operation prompt when a touch point moves to a target operation position of the operation prompt.

8. The method according to claim 7, further comprising:
obtaining touch position information of the touch operation;
determining a first deviation angle based on the touch position information and position information of an area baseline of a first display area, wherein the area baseline is a center line of the first display area; and
displaying the touch point corresponding to the touch operation in the operation prompt based on the first deviation angle.

9. The method according to claim 8, wherein during the displaying the touch point corresponding to the touch operation in the operation prompt based on the first deviation angle, the method further comprises:
when the touch point stops at a stop position in the operation prompt, updating the casting preview information of the target virtual item in the first virtual scene based on the first deviation angle.

10. The method according to claim 8, further comprising:
determining that the touch point moves to a stop position outside the first display area when the first deviation angle is greater than a target angle threshold;
using a difference between the first deviation angle and the target angle threshold as a perspective adjustment parameter; and
determining the second perspective based on the perspective adjustment parameter, and displaying the second virtual scene corresponding to the second perspective of the target virtual object.

11. The method according to claim 10, further comprising:
rotating the operation prompt matching the first perspective based on the perspective adjustment parameter, and determining a second display area matching the stop position;
displaying the operation prompt in the second display area;
determining a second deviation angle based on the touch position information and position information of an area baseline of the second display area;
displaying the touch point corresponding to the touch operation in the operation prompt based on the second deviation angle; and
updating the casting preview information of the target virtual item in the second virtual scene based on the second deviation angle when the touch point stops at the stop position in the operation prompt.

12. A control apparatus for a virtual object, comprising:
processing circuitry configured to:
display a target control in a display interface of a first virtual scene, the first virtual scene corresponding to a first perspective of a target virtual object;
display an operation prompt based on the first perspective on the target control and a touch operation, the operation prompt being configured to display a casting action range of a target virtual item;
display casting preview information of the target virtual item in the first virtual scene when the touch operation stops at a first stop position in the operation prompt; and
adjust the first virtual scene displayed in the display interface to a second virtual scene corresponding to a second perspective of the target virtual object.

13. The apparatus according to claim 12, wherein the processing circuitry further configured to:
adjust a display area in which the operation prompt displayed in the display interface with a touch point when the touch point moves.

14. The apparatus according to claim 12, wherein the processing circuitry further configured to:
cast the target virtual item in the first virtual scene on first casting preview information matching a first reference stop position and a first trigger operation on the first reference stop position in the operation prompt in a first display area.

15. The apparatus according to claim 14, the processing circuitry further configured to:
when the first reference stop position is adjusted to a second reference stop position and based on a second trigger operation on the second reference stop position, casting the target virtual item in the first virtual scene based on second casting preview information matching the second reference stop position.

16. The apparatus according to claim 15, the processing circuitry further configured to:
cast the target virtual item in the second virtual scene based on third casting preview information matching a third reference stop position and a third trigger operation on the third reference stop position in the operation prompt in a second display area.

17. A non-transitory computer-readable storage medium, storing instructions which when executed by a processor cause the processor to perform:
displaying a target control in a display interface of a first virtual scene, the first virtual scene corresponding to a first perspective of a target virtual object;
displaying an operation prompt based on the first perspective on the target control and a touch operation, the operation prompt being configured to display a casting action range of a target virtual item;
displaying casting preview information of the target virtual item in the first virtual scene when the touch operation stops at a first stop position in the operation prompt; and
adjusting the first virtual scene displayed in the display interface to a second virtual scene corresponding to a second perspective of the target virtual object.

18. The non-transitory computer-readable storage medium according to claim 17, wherein the instructions further cause the processor to perform:
based on a first trigger operation on a first reference stop position in the operation prompt in a first display area, casting the target virtual item in the first virtual scene based on first casting preview information matching the first reference stop position.

19. The non-transitory computer-readable storage medium according to claim 18, further comprises:
when the first reference stop position is adjusted to a second reference stop position, based on a second trigger operation on the second reference stop position, casting the target virtual item in the first virtual scene based on second casting preview information matching the second reference stop position.

20. The non-transitory computer-readable storage medium according to claim 19, further comprises:
based on a third trigger operation on a third reference stop position in the operation prompt in a second display area, casting the target virtual item in the second virtual scene based on third casting preview information matching the third reference stop position.
